(19) United States
(12) Patent Application Publication
(10) Pub. No.: US 2014/0080098 A1
(43) Pub. Date: Mar. 20, 2014

(54) SYSTEM AND METHOD OF EVALUATING AND REPORTING THE DRIVING ACUITY AND PERFORMANCE OF A TEST SUBJECT

(71) Applicant: Chadd I. Price, Livonia, MI (US)

(72) Inventor: Chadd I. Price, Livonia, MI (US)

(73) Assignees: HYUNDAI MOTOR COMPANY, Seoul (KR); HYUNDAI AMERICA TECHNICAL CENTER, INC., Superior Township, MI (US); KIA MOTORS CORPORATION, Seoul (KR)

(21) Appl. No.: 13/618,461

(22) Filed: Sep. 14, 2012

(51) Int. Cl. G09B 19/16

(52) U.S. Cl. 434/29

(57) ABSTRACT

Systems and methods for dynamically evaluating a test subject during operation/driving of a vehicle via an onboard evaluator are provided for herein. In particular, an onboard evaluator in the vehicle may be activated either automatically or manually by a user to dynamically evaluate the test subject of the vehicle and grade the test subject on his or her driving ability. Once the onboard evaluator has been activated, the location of the vehicle is preferably identified via a global positioning system (GPS) and local driving laws and rules are downloaded based on the identified location of the vehicle. The onboard evaluator then dynamically evaluates a test subject's driving skill set based on a test subject's driving acuity and performance. As the driving skill set is being evaluated, a processor continually calculates a driving grade/score for that particular test subject in relation to the test subject's evaluated driving skill set.

### FIELD OF THE INVENTION

The present invention relates to a system and method for evaluating and reporting driving abilities and habits of a test subject in a vehicle based on the test subject's performance and acuity during operation.

### BACKGROUND

Learning to drive can be a stressful, difficult and often a time consuming task for both the student and the teacher. Every year, parents spend hours upon hours teaching their children how to drive when they reach the appropriate driving age. Unfortunately, however, many parents in this day in age do not have the proper amount of time, patience or knowledge required to effectively teach their children how to drive. In fact, some parents themselves are poor drivers as well, and therefore, should not be teaching their children how to drive. As a result, these parents either spend hundreds of dollars on a driving instructor or, in some cases, let their children learn on their own. The later situation, however, increases the risk that that child will be involved in a motor vehicle accident given their insufficient level of training and poor driving skill set.

Each driver has an individual driving skill set that pertains specifically to that driver's habits, abilities, and awareness. For instances, one driver may be an excellent driver on rural roads while at the same time being a poor driver on city roads. Additionally, some drivers may be able to execute maneuvers on the road effectively while at the same time have difficulty parallel parking. Thus, it is often difficult for instructors to exactly pin point where each student driver needs the most help given the short duration of time they are with each driver.

Currently, the only way that individuals are evaluated on their driving abilities is via a parent or a driving instructor riding as a passenger, or by a simulator system. Driving instructors, as noted above however, are not always with the student while they are driving on a daily basis. Therefore, instructors are only aware of the driving habits the individual manifest when the instructor is present in the vehicle. Many times bad habits, especially in the case of new driver's, are more likely to manifest when the driver is driving alone, rather than with a person of authority, such as a parent or an instructor. This is due to the fact that the driver is nervous and overly cautious given the pressure of the situation. Therefore, the driver's actually abilities/habits are not reflected accurately by human observers, especially when the human observer is a parent or driving instructor.

Alternatively, as mentioned above, an individual may also learn to drive on a driving simulator. However, driving simulators do not account for all of local traffic rules, environments and situations which a driver might actually encounter in every locality. This is due to the fact that a simulator is a closed universe which can only recreate specific scenarios that have been preconceived by the simulator's creator. Additionally, simulators do not allow the driver to become accustom to how it actually “feels” to drive a vehicle and how that driver's specific vehicle is going to react to a particular driving process.

Furthermore, even individuals who have been driving for a long period of time may forget over time how to properly execute certain driving techniques. In addition, some individuals may be unaware of new laws or different traffic laws. That is, for example, in some geographic localities it is legal for a driver to turn right on red after coming to a complete stop while in other states/cities this maneuver is not allowed at any time or at certain types of intersections. Often times, these individuals are unaware that they are operating the vehicle incorrectly and thus would not be likely to seek assistance to correct their deficiencies in their driving habits. This is especially true with new laws that have just been put in effect.

Therefore, there is a need for a dynamic onboard driving evaluator in the vehicle itself that is configured to evaluate a test subject (e.g., driver or passenger) in real time, provide the test subject with instructions on how to execute certain driving situations correctly for a given geographic locality in which the vehicle is currently operating when the vehicle encounters specific scenarios on the roadway and provide the test subject and/or other individuals interested in the test subject's abilities with an up-to-date driving grade based on the test subject's current driving skill set and habits.

### SUMMARY

Systems and methods for dynamically evaluating a test subject during operation/driving of a vehicle via an onboard evaluator are provided for herein. In particular, in one embodiment of the present invention an onboard evaluator in the vehicle may be activated either automatically or manually by a user (e.g., a driver, passenger, or third party) to dynamically evaluate the test subject of the vehicle and grade the test subject on his or her driving ability. Once the onboard evaluator has been activated, the location of the vehicle is preferably identified via a global positioning system (GPS) and local driving laws and rules are downloaded based on the identified location of the vehicle. The onboard evaluator then dynamically evaluates a test subject's driving skill set based on a test subject's driving acuity and performance. As the driving skill set is being evaluated, a processor continually calculates/a driving grade/score for that particular test subject in relation to the test subject's evaluated driving skill set.

In some exemplary embodiments of the present invention, the onboard evaluator may be automatically activated by a remote information transmission device when the test subject either approaches the vehicle with the remote information transmission device or a key is input into the ignition of the vehicle. In this case, the on board evaluator may continually search for remote information transmission devices once power has been applied to the on board evaluator by any known system or method. Then once a specifically coded remote information transmission device is found, the system may identify the remote information transmission device and download data that is associated with the coded remote information transmission device. This data may be stored within a hard drive within the vehicle or remotely on a telematics server (e.g., in a cloud network).

Alternatively, in some exemplary embodiments of the present invention, the onboard evaluator may be activated manually by a user selecting an application on a touch screen system, and logging into the application when no specifically coded remote information transmission device is found by the system. In this exemplary embodiment, a user is required to manually log into the onboard evaluator before the onboard evaluator is activated. The user may be an instructor, parent, the test subject or any other third party who controls the activation of the onboard evaluator. Like in the prior exemplary embodiment, once a user has logged in, data that is associated with that particular log-in is then downloaded to the evaluator to be used in the evaluation process.

Furthermore, in some exemplary embodiments of the present invention, it should be noted that the test subject may be either a driver or a passenger. When the test subject is a driver, the onboard evaluator may also be configured to activate automatically a voice control system to communicate with the driver instructions and notifications while the vehicle is in operation through one or more teaching moments displayed on a display device such as screen. If the test subject is a passenger, data may be directed only to the a display device to display teaching moments to the passenger that correlate with the driver's current operation of the vehicle so that the passenger may learn from the driver's actions and see why the driver is performing certain actions. These teaching moments may be transmitted to a remote device via a wireless connection (e.g., via Bluetooth technology) or may be displayed on an integrated screen in the vehicle via (e.g., a Controller Area Network (CAN)).

In addition, evaluation of the test subject's acuity and performance during operation of the vehicle may further include monitoring a plurality of vehicle sensors to determine whether or not the test subject is executing driving processes correctly, determining whether or not any one of a plurality of road rules have been broken by the test subject, and continuously analyzing the environment around the vehicle and identifying whether a teaching moment is present based on data received from the plurality of sensors. When a teaching moment is present, a teaching moment may be displayed on either, e.g., a remote touch screen device or an integrated display device in the vehicle and the data is logged in association with the test subject. Instructions related to the teaching moment may be vocalized over one or more speakers in the vehicle or remote device to provide the test subject with audio instructions as well as video instructions on how to execute a particular driving operation.

When, however, the onboard evaluator determines that a rule has been broken by the test subject, the violation may also be logged in the memory of the onboard evaluator or on a remote server and utilized to calculate or recalculate the test subject's grade. This grade may be transmitted to a remote display device so that that device may report the test subject's driving grade to the appropriate individuals (e.g., third parties such as the test subjects parents, instructor, etc.). Furthermore, the onboard evaluator may offer certain test subject's certain tutorials based upon data related to the test subject's driving habits which has been collected by the onboard evaluator so that the test subject may better understand the rules and laws which they are violating and how to execute those maneuvers appropriately once operation of the vehicle has ceased.

Advantageously, the exemplary embodiment of the present invention allows parent and instructors to better monitor the ability of young or inexperienced drivers continuously without having to actually be present in the vehicle. Additionally, the illustrative embodiment of the present invention provides real time illustration and audio feedback on how to execute specific driving maneuvers at the same time as when the test subject encounters a situation in which that particular driving maneuver is required. Therefore, the stress, time and cost associated with teaching a young or inexperienced driver how to drive can be reduced.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 is a schematic block diagram illustrating an exemplary system for executing processes of the exemplary embodiment of the present invention;

FIG. 2 is a is a flow chart illustrating an exemplary algorithm which is executed by the system of FIG. 1 in accordance with the exemplary embodiment of the present invention;

FIG. 3 is an exemplary display of a teaching moment in accordance with the exemplary embodiment of the present invention;

FIG. 4 is an exemplary report which is generated in accordance with the exemplary embodiment of the present invention; and

FIG. 5 is an exemplary grade report which may be displayed in accordance with the exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although the below exemplary embodiment is described as using a single processor to execute the above processes, it is understood that the above processes may also be performed by a by a plurality of processors on a plurality of controllers/devices throughout the vehicle without departing from the metes and bounds of the exemplary embodiment of the present invention.

Furthermore, the control logic of the exemplary embodiment of the present invention may be embodied as non-transitory computer readable media on a computer readable medium containing executable program instructions executed by the processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

More specifically, the present invention provides an onboard evaluator that is configured to dynamically evaluate a test subject during operation/driving of a vehicle via an onboard evaluator are provided for herein. In particular, in one embodiment of the present invention an onboard evaluator in the vehicle may be activated either automatically or manually by a user (e.g., a driver, passenger, or third party) to dynamically evaluate the test subject of the vehicle and grade the test subject on his or her driving ability. Once the onboard evaluator has been activated, the location of the vehicle is preferably identified via a global positioning system (GPS) and local driving laws and rules are downloaded based on the identified location of the vehicle. The onboard evaluator then dynamically evaluates a test subject's driving skill set based on a test subject's driving acuity and performance. As the driving skill set is being evaluated, a processor continually calculates/a driving grade/score for that particular test subject in relation to the test subject's evaluated driving skill set.

In addition, evaluation of the test subject's acuity and performance during operation of the vehicle may further include monitoring a plurality of vehicle sensors to determine whether or not the test subject is executing driving processes correctly, determining whether or not any one of a plurality of road rules have been broken by the test subject, and continuously analyzing the environment around the vehicle and identifying whether a teaching moment is present based on data received from the plurality of sensors. When a teaching moment is present, a teaching moment may be displayed on either, e.g., a remote touch screen device operating an application that communicates with the vehicle or an integrated display device in the vehicle, and the data is logged in association with the test subject. Instructions related to the teaching moment may be vocalized over one or more speakers in the vehicle or remote device to provide the test subject with audio instructions as well as video or written instructions on how to execute a particular driving operation.

When, however, the onboard evaluator determines that a rule has been broken by the test subject, the violation may also be logged in the memory of the onboard evaluator or on a remote server and utilized to calculate or recalculate the test subject's grade. This grade may be transmitted to a remote display device so that that device may report the test subject's driving grade to the appropriate individuals (e.g., third parties such as the test subjects parents, instructor, etc.). Furthermore, the onboard evaluator may offer certain test subject's certain tutorials based upon data related to the test subject's driving habits which has been collected by the onboard evaluator so that the test subject may better understand the rules and laws which they are violating and how to execute those maneuvers appropriately once operation of the vehicle has ceased.

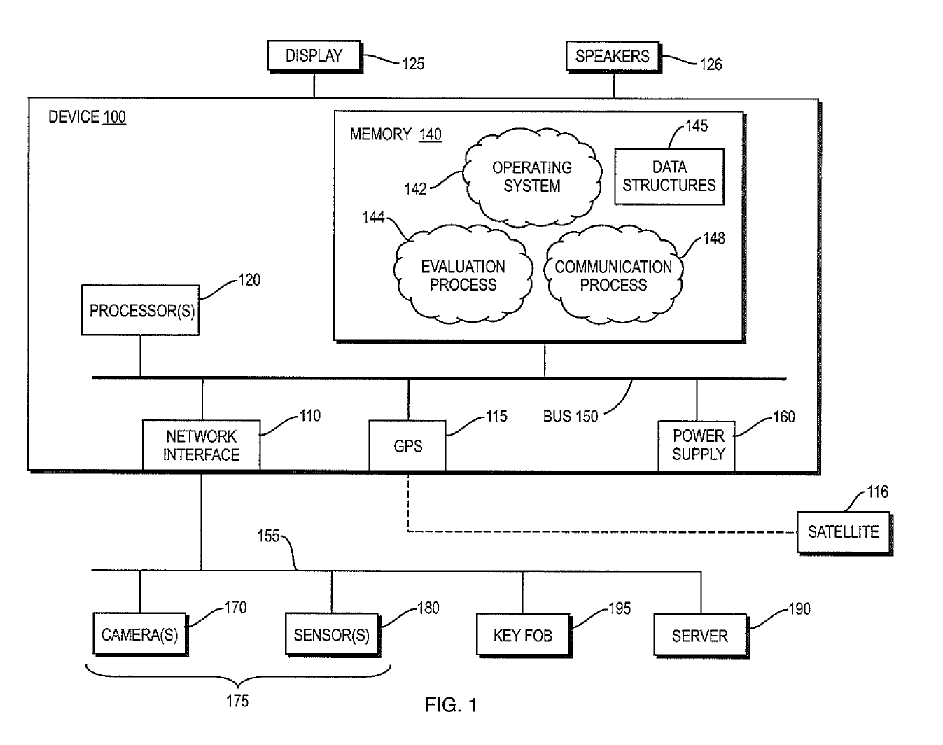

The exemplary embodiment of systems and methods of the present invention will now be described with reference to FIGS. 1-5.

FIG. 1 is a schematic block diagram of an example device 100 that is configured to execute the exemplary onboard evaluator 144 that may be used in relation to the exemplary embodiment of the present invention. The device may include one or more network interfaces 110 (e.g., wired, wireless, PLC, or the like) that is able to connect to any one of a number of networks, such as Controller Area Network (CAN), telematics network, etc. The device 100 also includes at least one processor 120, and a memory 140 interconnected by a system bus 150, as well as a power supply 160 (e.g., battery, plug-in, etc.) and a Global Positioning System (GPS) transceiver 115. The device 100 may also be connected to speakers 126 and display device 127 for communicating with the test subject.

The network interface(s) 110 contain the mechanical, electrical, and signaling circuitry for communicating data over links coupled to a network. Whether those links are wired or wireless is irrelevant to the illustrative embodiment of the present invention as either may be used. The network interfaces may be configured to transmit and/or receive data using a variety of different communication protocols. Note, further, that the device may have two different types of network connections 110, e.g., wireless and wired/physical connections, and that the view herein is merely for illustration. Also, while the network interface 110 is shown separately from power supply 160, the network interface 110 may communicate through the power supply 260, or may be an integral component of the power supply. In some specific configurations the signal may be coupled to the power line feeding into the power supply 160. Likewise, although the GPS transceiver is illustrated as being a part of the device 100, the transceiver 115 may also be located remotely from the device within the vehicle. In this case, a location data would be transmitted to the device via an intermediate controller installed in the vehicle. Accordingly, the location of the transceiver is not limited thereto.

The memory 140 includes a plurality of storage locations that are addressable by the processor 120 and the network interfaces 110 for storing software programs and data structures associated with the embodiments described herein. Note that certain devices may have limited memory or no memory (e.g., no memory for storage other than for programs/processes operating on the device and associated caches). Alternatively, the data utilized by the processes in these types of memory systems may be stored on a remote server 190 and downloaded to and uploaded from the device 100 accordingly through the network interface 110.

The processor 120 may include necessary elements or logic configured to execute the software programs and manipulate the data structures 145. An operating system 142, portions of which are typically resident in memory 140 and executed by the processor, functionally organizes the device 100 by, inter alia, invoking operations in support of software processes and/or services executing on the device. These software processes and/or services may also include the illustrative onboard evaluator 144, and a communication process 148. Note that while the communication process 148 is shown in centralized memory 140, alternative embodiments provide for the process to be specifically operated within the network interfaces 110. The communication process 148 may be any known method of communication between two or more devices, e.g., Bluetooth, Wi-Fi, etc. Accordingly, the illustrative embodiment is not limited to any specific type of communication process and instead is intended to include all communication process which are capable of transferring data within a vehicle.

Furthermore, the network interface(s) 110 may be configured to communicate with a plurality of sensory objects 175. These sensory objects 175 may be any one of a plurality of imaging devices (e.g., cameras) or sensors (e.g., ultrasonic sensors) that are installed on, in or around the vehicle. It should be noted that although the exemplary embodiment is just illustrated as sensors and cameras in FIG. 1, the sensory objects 175 may also include internal measurement devices, such as a speedometers, an engine control unit(s) (ECU), an anti-lock braking system (ABS), a traction control system (TCS), etc. Therefore, the sensory objects 175 may include any module, device, or system which is capable of providing data to the onboard evaluator that can be used to evaluate and calculate a test subject's driving acuity and performance during vehicle operation. Accordingly, the sensory objects are not limited to those described above.

The GPS transceiver 115 may be configured to communicate with satellite 116 via signaling to locate the position of the vehicle and report the vehicle's position to the onboard evaluator. As noted above, the location of the GPS transceiver is not limited by the illustrative embodiment of the present invention and therefore should not be limited to the architecture defined herein. Thus, the location of the GPS transceiver in the device 100 in the exemplary embodiment of FIG. 1 is intended as exemplary only.

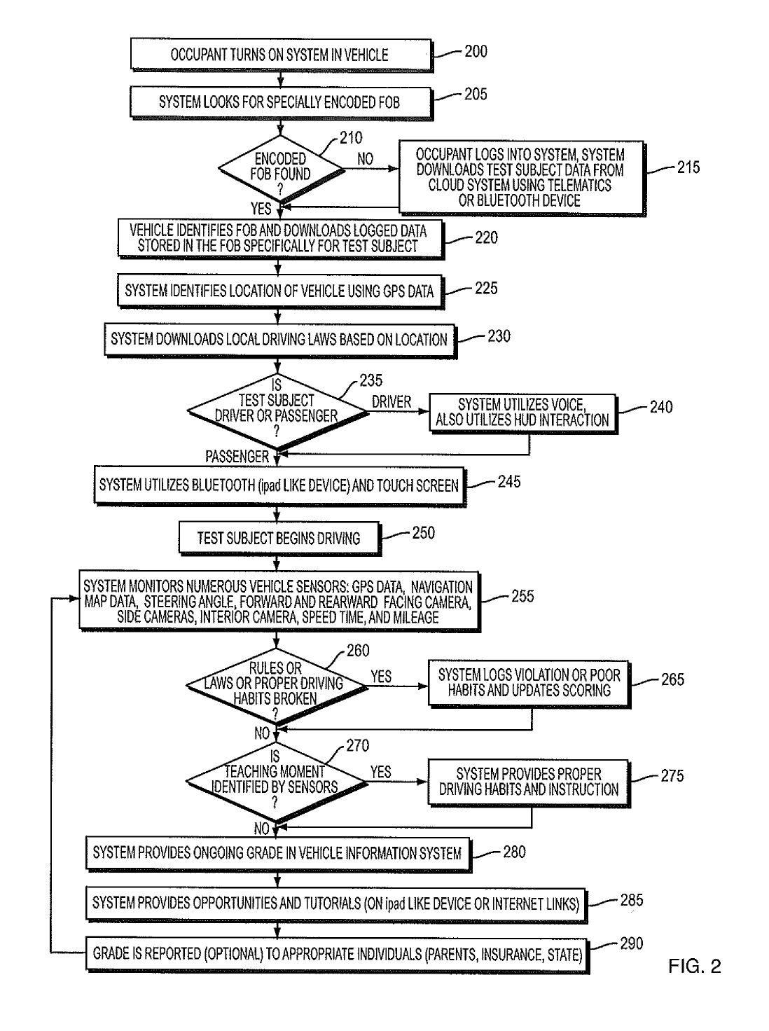

As mentioned above, the onboard evaluator 144 may be configured to execute a plurality of processes via the processor 120. FIG. 2 is a is a flow chart illustrating an exemplary algorithm which may be executed by the system of FIG. 1 in accordance with the exemplary embodiment of the present invention. It should be noted that the flow chart illustrated below is a simplified flow chart of the system and methods, and thus the actual chart could be much more complicated with many other options depending on the actual situations input by the developer which are not necessary to the overall operation of the system, but to their unique configuration. Furthermore, as stated above, the control logic for executing the algorithmic process below may be embodied on a non-transitory computer readable medium or stored on a memory or hard drive of the device 100.

Accordingly, the device 100 executes a startup, monitoring and grading process as will be described below. However, as mentioned above, the algorithmic abilities of the illustrative embodiment of the present invention are not limited to the process discussed below and should be construed to be able to include additional options and features which may be integrated therein and known to be easily integrated by those skilled in the art.

Startup Process

More specifically, once the onboard evaluator 145 is supplied with power from the power supply 160, due to the device 100 being automatically powered on or a user manually applying power to the device 100, the onboard evaluator 145 (“the system”) may request that at least one network interface begin searching in step 205 for one or more specially encoded remote information transmission device(s) 195 which have been previously authenticated by device. The system may be, for example, configured to search a predefined radius outward from the vehicle for one or more remote information transmission devices that have been previous authenticated by the vehicle, or may be configured to only use a remote information transmission device that is in the ignition at that time. The searching process maybe performed by a transmitter or any one of a plurality of well now methods for detecting and authenticating a remote information transmission device. Accordingly, the description of which will be omitted for brevity.

If a specially coded remote information transmission device 195 is identified in step 210, the onboard evaluator is automatically activated and the remote information transmission device is identified in step 220. The remote information transmission device 195, may be a key fob, phone, card or any other storage device that is capable of transmitting information to a receiver at close range. Once the remote information transmission device is identified in step 215, the data associated with the that remote information transmission device may be downloaded to the memory 140 or the data on the remote information transmission device maybe used to merely identify the one or more test subjects that already have information stored on a memory to dynamically evaluate the test subject of the vehicle and grade the test subject on his or her driving ability. This data, much like the manual activation process described below, may be downloaded from a centralized server via, e.g., a cloud network using, e.g., a telematics system or Bluetooth device.

If a specially encoded remote information transmission device 195 is not found by the system in step 210, the system requires a test subject to log into the system manually in order for the system to be activated in step 215. Once the systems is activated, the system may automatically download that particular test's subjects data from a centralized server via, e.g., a cloud network using, e.g., a telematies system, Bluetooth device, or form internal memory 140 in step 205.

Once activated, the system may request that a Global Positioning System (GPS) identify the location of the vehicle in step 225 through the transceiver 115. Based on the location of the vehicle, the system is able to identify an environment/locality in which the vehicle is being operated and download the local driving rules and regulations (laws) for the environment/locality in which the vehicle is operating in step 230. The environment/locality in which the vehicle is operating may refer to a town, city, state, country, or any combination thereof. Furthermore, the identified environment may also include weather information that allows the system to reevaluate how the vehicle should be operated given the current weather conditions.

Although the above description is tailored toward the test subject being the driver of the vehicle, the test subject may also be a passenger in which the passenger is asked questions about the driver's ability and how the driver should execute certain operations of the vehicle in response to real-time scenarios in which the vehicle is operating. In this case, the system would be configured to determine in step 235 whether or not the test subject is a passenger or the driver, and based on this determination, conduct the evaluation accordingly. If, however, the test subject is determined to be the driver, the system may automatically activate in step 240 a voice control system to communicate with the driver and control the onboard evaluator 145.

Once the vehicle has been located and the environment/locality and rules/laws for the identified environment/locality have been downloaded, the vehicle operation is then monitored by the onboard evaluator to dynamically evaluate the test subject's driving skill set based on how well the test subject is able to execute or identify driving processes that are currently being executed by the driver.

The below described monitoring process is based upon the assumption that the test subject is a driver. In this instance, the system may be configured to automatically activate a voice control system to communicate with the driver in step 240 as mentioned above. The voice control system accordance with the illustrative embodiment of the present invention may be any well known voice control system that can be utilized to control and communicate with the systems of the vehicle via the driver. Therefore, the operation thereof will be omitted for brevity.

However, regardless of whether the test subject is the driver or a passenger, the system may preferably be configured to connect to a remote device such as a touch screen through any well known data connection and transmission medium, such as Bluetooth, WI-Fi, a wired connection etc in step 245 and execute the monitoring process below.

Monitoring Process

Once the vehicle begins moving in step 250, the system then begins to monitor a plurality of vehicle sensories 175 to determine whether or not the test subject is executing driving processes with a high degree of acuity and performance (i.e., correctly and safely) in step 255. As discussed above the plurality of vehicle sensories 175 may include front, rear, and side exterior cameras, interior cameras, GPS data, steering angle controllers, measurement devices such as speedometers, odometers, and timers or any other device which is able to provide data to the onboard evaluator/system that relates to how the test subject is operating the vehicle. Therefore, the number and type of sensories utilized by the illustrative embodiment of the present invention is not limited thereto.

Furthermore, the onboard evaluator 144 may more specifically be configured to determine whether or not any one of a plurality of road rules have been broken by the test subject in step 260. As a result, each time a road rule or law is violated by the test subject, the system logs the violation in a storage device such as a memory or hard drive in step 265. Alternative, the system may also be configured to log poor habits on the part of the test subject that are not necessarily illegal but may increase the risk of the test subject getting into an accident in step 265 as well.

Another aspect of the illustrative embodiment of the present invention is that the system may also be configured to continuously evaluate the exterior surroundings and identify whether a teaching moment is present based on the data received from the plurality of sensories 175 in step 270. Then, if a teaching moment is identified, the system/onboard evaluator may be configured to display on one or more screens in the vehicle a proper execution technique for the test subject to follow or audibly communicate with the driver to provide the driver with verbal instructions in step 275. A teaching moment may be identified, for example, when a test subject approaches a four way stop intersection for the first time, when prior data stored in the system indicates that that particular test subject has failed to execute this type of scenario in the past correctly, or when the test subject has previous asked a question regarding this particular scenario in the past, etc.

In this exemplary embodiment of the present invention, the system may utilize the GPS system to recognize that the vehicle is approaching a specific scenario (in this instance a four way stop) and cameras installed around the outer periphery of the vehicle may be configured to confirm the four way stop and determine how many vehicles are located in the intersection and location of the vehicles. However, any method for obtaining this data may be used without departing from the overall embodiment of the present invention, and accordingly the illustrative embodiment.

Alternatively, the system may also be configured to identify a teaching moment based up on questions previously asked by the test subject and the test subject's previous poor driving habits. Accordingly, the identification of teaching moments is also not necessarily limited to only instances in which the test subject has never encountered before, and should not be construed as such.

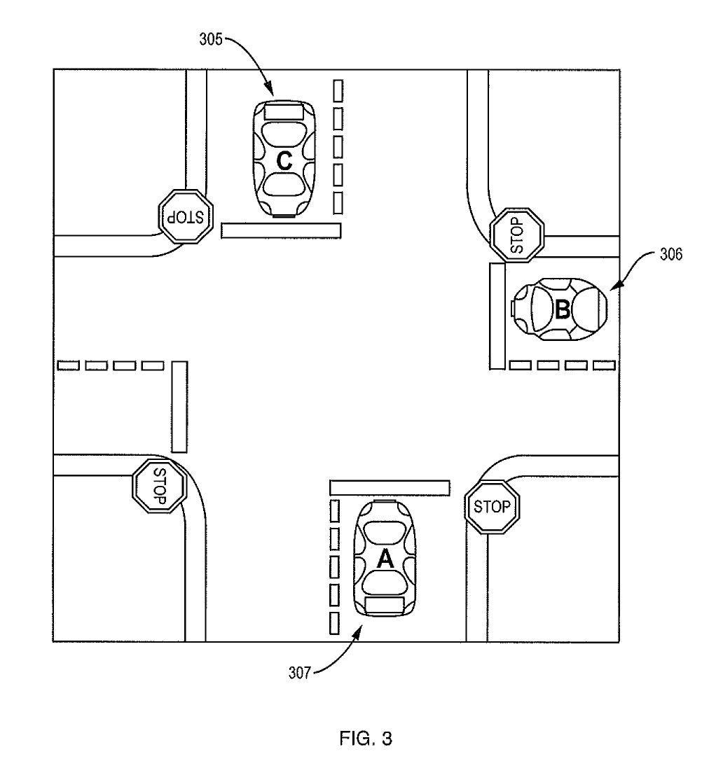

Regardless, once a teaching moment has been identified, like the four way stop discussed above, the system, as illustrated by the diagram shown in FIG. 3, may be configured to display and audibly describe how the test subject should properly execute identified scenario, in this case a four way stop. For instance, if the vehicle 307 approaches at same time of other vehicles 305, 306, the voice control system may be configured to notify the test subject that vehicle 306 to the right of the test subject's vehicle 307 has the “right-of-way,” tell test subject that vehicle 307 must come to complete stop, and tell the test subject that opposite vehicles 205 can go at same time as the test subject's vehicle 307, but not before vehicle 306. The test subject may also be shown on the display device 125 (FIG. 1) as well in some exemplary.

As the 4-way stop is executed, system may use a camera(s), GPS, and/or other sensories 175 to determine if the test subject navigated and executed the four way stop appropriately. The test subject's acuity and performance data are then stored for use in calculating the test subject's driving grade or grades by the onboard evaluator in step 280 and may flag tutorials that the test subject can later be provided with on a remote device in step 285. Furthermore, the grade may be sent via email, text, or any data transmission to appropriate individuals such as the test subject's parents, instructor, insurance company, department of motor vehicles, etc in step 290.

In another exemplary embodiment of the present invention, the system may determine that the vehicle is approaching a curve speed warning sign, via e.g., either a forward facing camera or GPS data. In this instance, the voice control system may be configured to tell the passenger that a yellow sign means a warning and that the curve ahead is sharp and the suggested speed is 25 MPH. In this case, preferably the speed sensor, steering wheel angle sensor, roll sensor, and accelerometer data may be logged as the test subject navigates the corner. Based upon, the acuity and performance of the test subject's navigation, the system may then determine how well the test subject navigated the corner and grade them on its execution. Additionally, in some exemplary embodiments of the present invention the system may also be configured to display a video and pictures of at least one roll-over accident on the display 125 or on a remote device to show passenger what might occur if they go too fast around the corner.

It should be noted that although the above described teaching moments do provide data which directly reflects the test subject's grade, the system also preferably continually monitors a the test subject's operation regardless of whether or not a teaching moment has been identified and uses all of the data collected during the monitoring process to evaluate and grade the test subject on his or her driving acuity and performance. This grading process is described below.

Grading Process

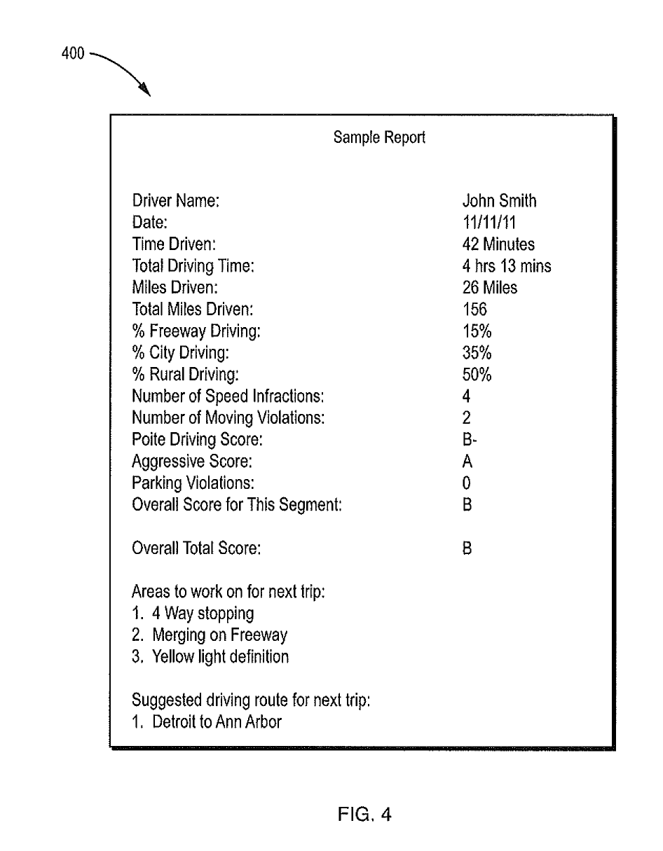

After enough data has been collected by the system, the system may generate a grade report like the one illustrated in FIG. 4. This grade report illustrated in FIG. 4 is for exemplary purposes only and should not be construed as limiting in nature. That being said, a grade report like the one illustrated in FIG. 4, may be provided to a remote device through email, text, or other data transmission methods to a plurality of third parties, such as the test subjects parents, instructor, insurance company etc.

In particular, this grading report 400 includes the driver's name, date, the amount of time and miles driven on this particular trip, as well as the total amount of driving time and miles the test subject has logged. Furthermore, the report 400 may also include the percentage of experience that particular driver has on the freeway, in the city, and rural roads to identify the driver's familiarity with certain environments.

The report may also include the number of speeding, parking and moving infractions respectively that have been violated by the test subject along with a polite driving score and aggressive driving score to better identify the test subject's driving habits. These scores may be either numerical or alphabetic in nature based upon standard testing procedures. These scores may also be culminated into an overall score that is a mean of the individual scores identified above. Based on upon these scores and violations, the report may also identified areas that the test subject should work on during the next trip and provide a suggested route that would allow the driver to encounter each of these scenarios.

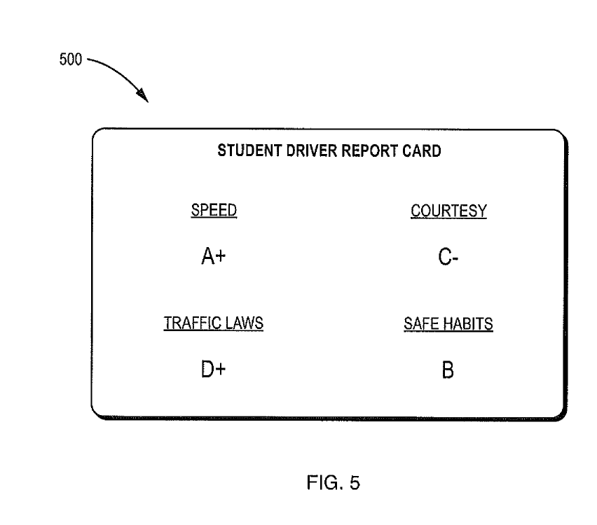

Additionally, as can be seen from FIG. 5, a categorized “report card” 500 can also be provided which allocates a letter grade to each category of operation of the vehicle. The categories may be for example speed, courtesy, traffic laws, or safety. It should be noted, however, that the illustrative embodiment of the present invention is not limited to these categories, thus may include any one of number of categories that are configurable by a user. The test subject's grades may also be compared to a national average of other test subject's so that the test subject can be made aware of how where he or she ranks.

Furthermore, the test subject's report card may be provided, in some exemplary embodiments of the present invention to the test subject via the display device 125 in the vehicle so that the test subject instantaneously comprehends his or her level of acuity and performance in operating a vehicle. Additionally, the report card 500 may also be provided to the test subject's parents, instructor, or any other third party previous designated in the system.

Advantageously, accordingly to the illustrative embodiment of the present invention, the above described onboard evaluator is able to provide test subjects with instant feedback to help subject understand better where they need to focus driving efforts in a dynamic and efficient manner, while at the same time effectively and efficiently informing parents of their children's abilities and allows parents/instructors to focus in on the areas in which the test subject needs help the most.

Finally, the illustrative embodiment of the present invention is also able to provide third parties (e.g., governmental motor vehicle departments and insurance companies) with this data as well. For instance, the government could use the above onboard evaluator data to replace a typical driving tests and reduce the work load on an already overworked agency. Likewise, insurance companies could provide high scoring individuals (i.e., with all A ratings) with reduced insurance rates based on the data collected showing they good driving habits.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly this description is to be taken only by way of example and not to otherwise limit the scope of the embodiments herein. Therefore, it is the object of the appended claims to cover all such variations and modifications as come within the true spirit and scope of the embodiments herein.

1. A method of dynamically evaluating a test subject of a vehicle via an onboard evaluator, the method comprising:
activating, by a power supply, the onboard evaluator in the vehicle;
identifying, by a processor, a location of the vehicle via a global positioning system (GPS);
downloading, by the processor executing the onboard evaluator, local driving laws based on the identified location of the vehicle;
dynamically evaluating, by the processor executing the onboard evaluator, a test subject's skill set based on an acuity and performance of the test subject's operation of the vehicle; and
displaying a grade in relation to the test subject's evaluated skill set.

2. The method of claim 1, wherein the onboard evaluator is activated by identifying a coded remote information transmission device.

3. The method of claim 2, further comprising:
before activating the onboard evaluator, searching for the coded remote information transmission device automatically by the onboard evaluator;
in response to locating the coded remote information transmission device, identifying the coded remote information transmission device; and
downloading data stored that is associated with the coded remote information transmission device in relation to the onboard evaluator.

4. The method of claim 1, wherein the onboard evaluator is activated manually by a user selecting an application on a touch screen system, and logging into the application accordingly.

5. The method of claim 1, further comprising:
before activating the onboard evaluator, searching for a coded remote information transmission device automatically;
in response to not finding the coded remote information transmission device, requiring the user to manually log into the onboard evaluator before the onboard evaluator is activated; and
downloading data that is associated with the user in relation to the onboard evaluator.

6. The method of claim 1, further comprising:
determining, by the processor, whether the test subject is a passenger or a driver;
in response to the test subject being a driver, activating a voice control system to communicate with the driver; and

7. The method of claim 6, further comprising connecting the onboard evaluator via a wireless communication media to a remote device.

8. The method of claim 7, wherein the remote device is a touch screen device operating a Bluetooth system.

9. The method of claim 1, wherein evaluating the test subject further includes:
monitoring a plurality of vehicle sensories to evaluate how well a test subject executes operation of the vehicle;
determining, by the onboard evaluator, whether or not any one of a plurality of road rules and laws have been broken by the test subject;
continuously evaluating environmental conditions around the vehicle and the location of the vehicle;
identifying whether a teaching moment is present based on the data received from the plurality of sensories; and
in response to identifying a teaching moment, instructing the test subject either audibly or visually with a proper execution technique for the current environment in which the vehicle is operating.

10. The method of claim 9, wherein in response to the onboard evaluator determining that a law has been broken by the test subject, logging the violation in the memory in association with that test subject and recalculating the test subject's grade.

11. The method of claim 1, wherein the onboard evaluator provides tutorials related to a specific test's subjects bad habits which are identified based upon the rules or laws a test subject violates.

12. The method of claim 1, wherein the grade is reported to one or more third parties.

13. A non-transitory computer readable medium containing program instructions executed by a processor or controller to dynamically evaluating a test subject of a vehicle via an onboard evaluator, the computer readable medium comprising:
program instructions that activate the onboard evaluator in the vehicle;
program instructions that identify a location of the vehicle via a global positioning system (GPS);
program instructions that download local driving laws based on the identified location of the vehicle;
program instructions that dynamically evaluate a test subject's skill set based on an acuity and performance of the test subject's operation of the vehicle; and
program instructions that display a grade in relation to the test subject's evaluated skill set.

14. The non-transitory computer readable medium of claim 13, wherein the onboard evaluator is activated by identifying a coded remote information transmission device.

15. A system configured to dynamically evaluate a test subject of a vehicle via an onboard evaluator, the system comprising:
a processor executing program instructions that are configured to activate the onboard evaluator in the vehicle, identify a location of the vehicle via a global positioning system (GPS), download local driving laws based on the identified location of the vehicle, dynamically evaluate a test subject's skill set based on driving acuity and performance of the test subject's, and provide a grade in relation to the test subject's evaluated skill set to one or more display devices.

16. The system of claim 15, the processor is further configured to:
before activating the onboard evaluator, search for a coded remote information transmission device automatically, in response to not finding the coded remote information transmission device, require the user to manually log into the onboard evaluator before the onboard evaluator is activated, and download via the network interface data that is associated with the user in relation to the onboard evaluator.

17. The system of claim 15, the processor s further configured to monitor a plurality of vehicle sensories to evaluate how well a test subject executes operation of the vehicle, determine whether or not any one of a plurality of road rules and laws have been broken by the test subject, continuously evaluate environmental conditions around the vehicle and the location of the vehicle identify whether a teaching moment is present based on the data received from the plurality of sensories, and instruct the driver either audibly or visually with a proper execution technique for the current environment in which the vehicle is operating in response to identifying the teaching moment.

18. The system of claim 17, wherein the environmental conditions are based on the location of the vehicle and weather conditions.

19. The system of claim 17, wherein in response to the determination that the law has been broken by the test subject, logging the violation in the memory in association with that test subject and recalculating the test subjects grade.

20. The system of claim 15, wherein the grade of the test subject is provided to one or more third parties.
